(19) United States
(12) Patent Application Publication
(10) Pub. No.: US 2005/0198459 A1
(43) Pub. Date: Sep. 8, 2005

(54) Apparatus and method for open loop buffer allocation

(75) Inventors: Zohar Bogin, Folsom, CA (US); Tuong Trieu, Folsom, CA (US); Sarath Kotamreddy, Chandler, AZ (US); Jayesh J. Laddha, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: General Electric Company

(21) Appl. No.: 10/795,037

(22) Filed: Mar. 4, 2004

(51) Int. Cl. G06F 12/00

(52) U.S. Cl. 711/167

(57) ABSTRACT

A method and apparatus for open loop buffer allocation. In one embodiment, the method includes loading requested data within a buffer according to a load rate. Concurrent with the loading of data within the buffer, the data is forwarded from the buffer according to drain rate. In situations where the load rate exceeds the drain rate, read requests may be throttled according to an approximate buffer capacity level to prohibit buffer overflow. In one embodiment, a rate for issuing data requests, for example, to memory, is regulated according to a predetermined buffer accumulation rate. Accordingly, in one embodiment, the open loop allocation scheme reduces latency while enabling sustained read streaming with a minimal size read buffer. Other embodiments are described and claimed.

### FIELD OF THE INVENTION

One or more embodiments of the invention relate generally to the field of integrated circuit and computer system design More particularly, one or more of the embodiments of the invention relates to a method and apparatus for an open loop buffer allocation to sustain read streaming with minimal read buffer size.

### BACKGROUND OF THE INVENTION

Communications between devices that make up an electronic system are typically performed using one or more busses that interconnect such devices. These busses may be dedicated busses coupling only two devices, or they may be used to connect more than two devices. The busses may be formed entirely on a single integrated circuit die, thus being able to connect two or more devices on the same chip. Alternatively, a bus may be formed on a separate substrate than the devices, such as on a printed wiring board.

As operating frequency and speed of certain devices has increased, the rate at which such devices can supply data may exceed the maximum data rate of slower devices. In other words, based on the operating frequency and speed of a source device, the rate of data bandwidth from a fast source device may exceed the rate of data bandwidth that can be successfully handled by a slow target device. Accordingly, buffer overflow may occur when a fast source device is writing to a slow target device.

One traditional technique for avoiding buffer overflow between fast source and slow target devices is a closed allocation loop scheme. Closed loop allocation uses feedback regarding remaining buffer space to avoid buffer overflow. Close loop allocation also requires a deeper size for the read buffer to ensure streaming of read data. Unfortunately, the deeper buffer size results in an increased gate count, increased die size and ultimately, higher costs. However, as a result of budgetary conditions, limitations on gate count and die size are generally imposed on product manufacturers.

Accordingly, conventional buffering of data, when writing from a fast source device to a slow target device, is generally performed according to a closed-loop scheme by using feedback about available space in the read buffer to determine when to launch additional data requests. Hence, a request is not launched to memory if there is no corresponding space available in a buffer. However, if die size is limited, closed-loop allocation schemes will lead to performance degradation within high performance hardware configurations.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system including buffer logic configured according to an open loop buffer allocation policy, in accordance with one embodiment.

FIG. 2 is a block diagram further illustrating the buffer logic of FIG. 1, in accordance with one embodiment.

FIG. 3 is a timing diagram illustrating an open loop buffer allocation, in accordance with one embodiment.

FIG. 4 is a flowchart illustrating a method for an open loop buffer allocation, in accordance with one embodiment.

FIG. 5 is a flowchart illustrating a method for initialization of an open loop buffer allocation, in accordance with one embodiment.

FIG. 6 is a flowchart illustrating a method for regulating issuance of data requests, in accordance with one embodiment.

FIG. 7 is a flowchart illustrating a method for detecting a buffer capacity condition, in accordance with one embodiment.

FIG. 8 is a flowchart illustrating a method for incrementing a buffer accumulation register or counter, in accordance with one embodiment.

FIG. 9 is a flowchart illustrating a method for calculating a minimum buffer slot value and program configuration registers to enable open loop buffer allocation, in accordance with one embodiment.

FIG. 10 is a block diagram illustrating various design representations or formats for simulation, emulation and fabrication of a design using the disclosed techniques.

### DETAILED DESCRIPTION

A method and apparatus for an open loop buffer allocation are described. In one embodiment, the method includes loading requested data within a buffer according to a load rate. Concurrent with the loading of data within the buffer, the data is forwarded (drained) from the buffer according to a drain rate. In situations where the load rate exceeds the drain rate, read requests may be throttled during detected buffer capacity conditions according to an approximate buffer capacity level. In one embodiment, a rate for issuing data requests, for example, to memory, is regulated according to a predetermined buffer accumulation rate. Accordingly, in one embodiment, the open loop allocation scheme reduces latency while enabling sustained read streaming with a minimal size read buffer.

System Architecture

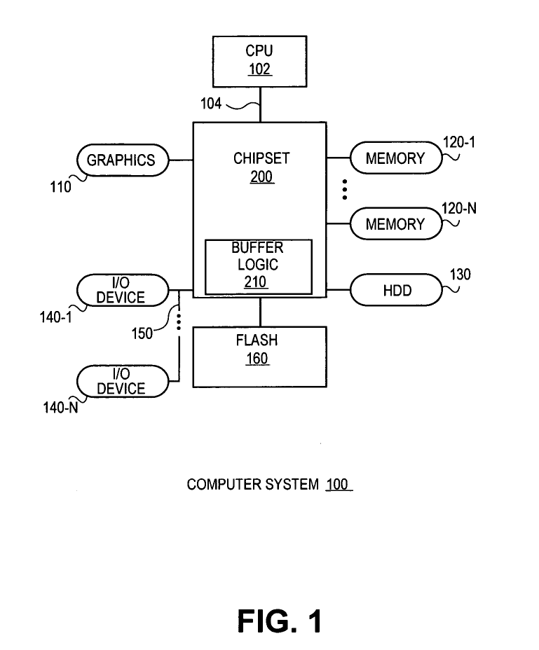

FIG. 1 is a block diagram illustrating computer system 100, including buffer logic 210 to implement an open loop buffer allocation policy, in accordance with one embodiment. Representatively, computer system 100 comprises a processor system bus (front side bus (FSB)) 104 for communicating information between processor (CPU) 102 and chipset 200. As described herein, the term “chipset” is used in a manner to collectively describe the various devices coupled to CPU 102 to perform desired system functionality. As described herein, each device that resides on FSB 104 is referred to as a bus agent of FSB 104. As such, the various bus agents of computer system 100 are required to arbitrate for access to FSB 102.

Representatively, chipset 200 may include graphics block 110, such as, for example, a graphics engine or chipset, as well as hard drive devices (HDD) 130 and main memory 120. In one embodiment, chipset 200 includes a memory controller and/or an input/output (I/O) controller. In an alternate embodiment, chipset 200 may operate as or include a system controller. In one embodiment, memory 200 is a multiple channel memory, such as a dual channel memory, and may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

Representatively, graphics 110 may be configured as an integrated graphics chipset, including a graphics accelerator. The graphics accelerator may include an instruction processing unit to control the graphics engine. As illustrated, chipset 200 provides graphics engine 110 with data from memory channels 120. In one embodiment, graphics engine 110 requires high data bandwidth, such as determined by a burst group length supported by graphics engine 110. As a result, the performance of graphics engine 110 is directly related to the amount of available bandwidth from memory 120.

As further illustrated, a plurality of I/O devices 140 (140-1, . . . , 140-N) may be coupled to chipset 200 via bus 150. As described above, each device that resides on a bus (e.g., I/O, memory, graphics, FSB or other bus) is referred to as a bus agent. In one embodiment, each bus agent arbitrates for bus ownership by asserting a bus request signal. In one embodiment, computer system 100 may be configured according to a three-bus system, including, but not limited to, an address bus, a data bus and a transaction bus. Accordingly, a bus agent issues an address bus request signal (ABR), a data bus request signal (DBR) or a transaction bus request (TBR) signal to request bus ownership to issue bus transactions.

A bus transaction can exhibit several bus protocol events. These include an arbitration event to determine bus ownership, between competing bus agents. Thereafter, the transaction enters the request phase where the bus owner drives transaction address information. Accordingly, when the request phase includes a data request, the bus agent requesting data may be referred to herein as an “initiator bus agent”. Following transaction initiation, a data phase results in a bus agent providing the requested data to the initiator bus agent. As described herein, the bus agent from which data is requested is referred to herein as a “completer bus agent”. As further described herein, the completer bus agent may be referred to as a “master bus agent”, whereas the initiator bus agent may be referred to as a “target bus agent”.

Accordingly, computer systems, such as computer system 100, generally utilize shared bus architectures to provide communication among devices. Devices, such as processors, memory controllers, I/O controllers and direct memory access (DMA) units are usually connected via a shared bus. In general, only one device can drive the bus at a given time. Hence, it is necessary to arbitrate between devices requesting bus ownership to prevent multiple devices from driving the bus simultaneously.

Within computer system 100, the rate at which a master bus agent (e.g., memory 120) can supply data may exceed the maximum bandwidth supported by a target bus agent (e.g., graphics engine 110) in high performance system configurations. As a result, buffering of such data prior to forwarding of the data to the target bus agent may lead to buffer overflow. Conventional techniques for averting buffer overflow include closed loop allocation schemes, which use feedback about remaining space in a read buffer, and generally require a deeper sized buffer to ensure streaming of read data. However, when gate count budgets and die size are restricted, such budgetary concerns prohibit the use of conventional closed loop allocation schemes.

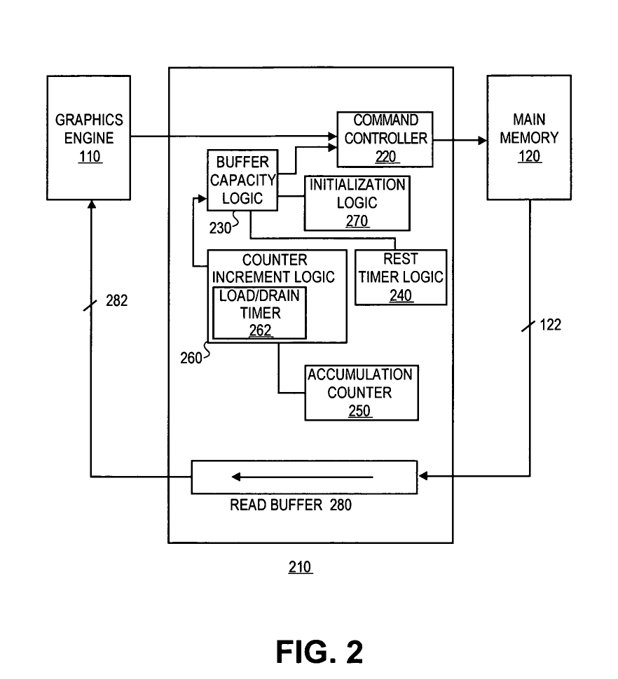

Accordingly, in one embodiment, buffer logic 210 performs open loop buffer allocation. As illustrated in FIG. 2, in one embodiment, read data 122 obtained from memory 120 according to a memory (load) clock domain is temporarily stored (loaded) in read buffer 280 and forwarded (drained) to graphics engine 110 in a graphics (drain) clock domain. However, continual streaming of or issuing of read requests to memory 120 may overflow read buffer 280 if the load rate from memory exceeds the drain rate to graphics engine 110. Accordingly, in one embodiment, command controller 220 regulates launching of data requests to memory to avoid buffer overflow for those system configurations where the load rate from a bus master exceeds the drain rate to a target bus agent.

Representatively, as illustrated in FIG. 2, buffer capacity logic 230 is to approximate the capacity of read buffer 280 without requiring feedback from read buffer 280. In one embodiment, a load rate for loading data from a bus master within read buffer 280, and a drain rate for draining data from read buffer 280 to a target bus agent are used to determine a buffer accumulation rate as a function of time. Accordingly, buffer capacity logic 230 may monitor, for example, accumulation counter 250 to approximate when buffer 280 begins to approach full buffer status, referred to herein as a “buffer capacity condition”. When a buffer capacity condition is detected, buffer capacity logic 230 may throttle the loading of data within buffer 280.

In one embodiment, approximation of the buffer capacity level of buffer 280 without feedback information begins by analyzing system configuration parameters. For example, in one embodiment, a memory clock frequency of memory 120 is, for example, 166 megahertz (MHz). In the embodiment illustrated, memory 120 is configured as a dual channel DDR memory resulting in a clock period of 6 nanoseconds (ns). Conversely, in one embodiment, graphics clock frequency is equal to 266 MHz, resulting in a clock period of 3.75 ns. As further illustrated, dual channel memory 120 enables the reading of a hex word (HW) defined as 256 bits, or 32-bytes, of data during each memory clock period.

Conversely, graphics engine 110 is able to support the forwarding of an octal-word (OW) defined as 128 bits, or 16-bytes, of data during each graphics clock period. Representatively, in this configuration, the load rate of data into read buffer 280 is 1 HW of data every memory clock (or 256 bits every 6 ns) for an effective load rate of 5.33 megabits per second (M/s). Conversely, the effective drain rate of data from read buffer 280 to graphics engine 110 is 1 OW of data every graphics clock (or 128 bits every 3.75 ns) for an effective drain rate of 4.26 M's.

Hence, the load-to-drain rate ratio is 1.25 (i.e., a 5:4 load-to-drain ratio) in an equal time elapsed interval. Accordingly, based on a predetermined load-to-drain rate ratio, in one embodiment, a load constant is set to a value equal to the load rate. In one embodiment, the load constant is used to program a load drain timer 262. In one embodiment, the timer 262 counts down to a value of zero as long as a read request is acknowledged or the accumulation counter indicates outstanding data. Once timer 262 expires, the programmed load constant is reloaded and countdown continues as long as there is further committed data to process.

In one embodiment, counter increment logic 260 includes load/drain counter 262. Representatively, once load/drain timer 262 expires, accumulation counter 250 is incremented. In one embodiment, accumulation counter 250 represents an approximate buffer accumulation depth. In one embodiment, accumulation counter 250 is initialized to zero and incremented in units of HW by the amount of read data committed to the read buffer (32-bytes every load clock). Conversely, accumulation counter 250 is decremented in units of HW by an amount of read data that has been drained within one to drain-to-load ratio period.

In a further embodiment, a constant value is used to determine a number of minimum buffer slots required to prevent buffer overflow. Accordingly, a minimum buffer slots value is a measure of how close buffer 280 is to getting full. In determining the minimum buffer slots value, an extra margin of safety is provided to account for system boundary conditions. As further illustrated in Table 1, due to discrepancy from a load clock domain to a drain clock domain, a crossing clock penalty from the load clock domain to the drain clock domain is calculated to determine the minimum buffer slots value.

TABLE 1
Analysis of Initial Latency to Compute Buffer Full Settings
Load Clock Domain

Clock

| | 1 | 2 | 3 | 4 | 5 |
|---|---|---|---|---|---|
| Data Write Latch | Active | | | | |
| Enable of a | load of | | | | |
| particular entry | 32 B | | | | |
| Data Write Latch | | Active | | | |
| Enable of a | | | | | |
| particular entry | | | | | |
| Data Write Latch | | | Active | | |
| Enable of a | | | | | |
| particular entry | | | | | |
| Data Load | n + 1 | n + 2 | n + 3 | n + 4 | n + 5 |
| pointer | | | | | |

Drain Clock Domain

| | Clock | | | | | | | | |
|---|---|---|---|---|---|---|---|---|---|
| | 1 | 2 | 3 | 4 | 5 | 6 | 7 | 8 | 9 |
| Sync 0 Data | | n + 1 | | | | | | | |
| Load pointer | | | | | | | | | |
| Sync 1 Data | | | n + 1 | | | | | | |
| Load pointer | | | | | | | | | |
| cphase | | | Wrong | Right | | | | | |
| penalty | | | phase | phase | | | | | |
| Data | | | | Sampled | Sampled | | | | |
| Consumption | | | | at end of | at end of | | | | |
| | | | | this period | this period | | | | |
| | | | | 1st 16 B | 2nd 16 B | | | | |
| Margin for | | | | | | 1 drain | | | |
| data hold | | | | | | clock | | | |
| time | | | | | | hold time | | | |
| | | | | | | margin | | | |

For example, as illustrated in Table 1, it takes six drain clocks of elapsed time from loading the first 32-bytes of data in buffer 280 in memory clock domain to completion of draining the first 32-bytes of data from buffer 280 in graphics clock domain. In other words, starting from an empty read buffer 280 during the first six memory clocks, there is no concurrent load and drain of data to graphics engine 110. After this initial period, load and drain happen concurrently at steady state with the deterministic load-to-drain ratio. In one embodiment, this initial period determines the minimum buffer slots value that must not be visible to steady state operation.

Accordingly, based on the sample system parameters above, six drain clocks equate to four load clocks. In one embodiment, this value of four load clocks equates to four buffer slots of reserved storage for the load-to-drain crossing penalty of Table 1 and serves as a baseline to select a buffer full constant value. In one embodiment, the approximate buffer level is measured by accumulation counter 250, which is incremented each time load/drain timer 262 expires. In one embodiment, buffer 280 may include a buffer depth (256 bits) equal to eight. Hence, the buffer full constant value may be set to four. Accordingly, in one embodiment, a buffer capacity condition is detected when accumulation counter 250 is equal to the buffer full constant value.

In one embodiment, detection of a buffer capacity condition causes command controller 220 to throttle issuance of read requests to, for example, memory 120. Representatively, rest timer logic 240 may be programmed according to a predetermined rest delay to increase a number of free buffer slots in buffer 280 to avoid buffer overflow. Accordingly, computer system 100 is able to sustain continuous read streaming required by, for example, graphics engine 110 while avoiding frequent start data streaming/stop data streaming type behavior to minimize arbitration penalties resulting from unavailability of data.

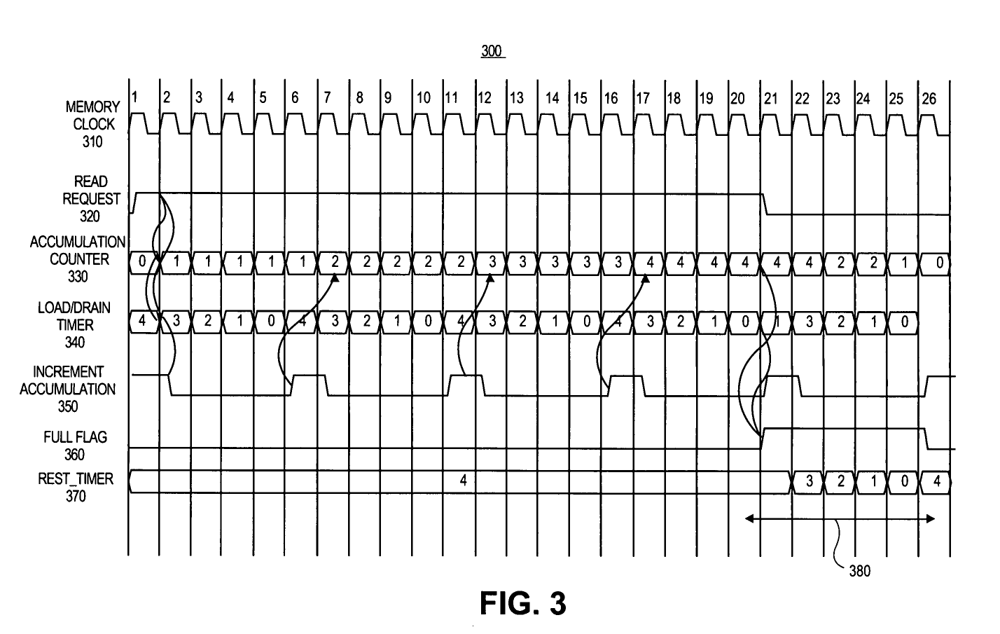

FIG. 3 depicts a timing diagram 300 to further illustrate the open loop buffer allocation provided by buffer logic 210 of FIG. 2. As illustrated by FIG. 2, with a load-to-drain ratio of 5:4 and a burst group length equal to 25 load clocks, or 150 ns, 20 requests of size HW each are launched by command controller 220 and there is a predetermined rest delay 380 of 5 memory clocks where no request is launched. In the same time interval, which is equal to 40 graphics clocks, with an OW of data consumed every graphics clock, a total of 40 OWs, or 20 HWs are drained from read buffer 280, resulting in achievement of maximum graphics bandwidth while avoiding read buffer overflow.

Representatively, full flag 360 is asserted when accumulation counter signal 330 reaches a preprogrammed value, such as the buffer full constant value. However, as described herein, the terms “assert”, “asserting”, “asserted”, “assertion”, “set(s)”, “setting”, “deasserted”, “deassert”, “deasserting”, “deassertion” or the like terms may refer to data signals, which are either active low or active high signals. Therefore such terms, when associated with a signal, are interchangeably used to require either active high or active low signals.

Accordingly, once full flag 360 is asserted indicating a buffer capacity condition, buffer capacity logic 230 will direct command controller 220 to throttle issuance of read requests until rest timer logic 240 has expired. In one embodiment, a value of rest timer logic 240 should be an interval long enough to drain buffer 280 from the full level down to a level X from where the quality of load-to-drain visible latency versus drain of remaining data in the buffer is equal. Selecting a sufficient rest interval 380 will give continuous bursts of data on the drain side.

In one embodiment, buffer level X from restart to full determines a length of the next burst group. As described herein, a burst of data requests are issued to memory to provide constant read streaming of data to graphics engine 110. In the above example, the initial latency in load clocks as described above is equal to four clocks. Thus, a value of five is chosen as the predetermined number of rest clock periods (in the load clock domain). During this period, read requests to memory errors are suppressed. In addition, the rest timer times an inactive load period to allow the drain side of the read buffer to reduce the buffer level.

Representatively, the open loop allocation policy supports configurations where the load rate in the buffer is less than or equal to the drain rate. However, calculation of the load-to-drain ratios, full constant settings and crossing clock penalties will vary according to the various load clock domains and drain clock domains of a system. Accordingly, the system configuration parameter values described herein are provided to illustrate one or more embodiments and should not be interpreted to limit or narrow the embodiments described herein. Although the above description is in the context of the load being memory and the drain being a graphics engine, other sources and drains for data may benefit from embodiments described herein. Procedural methods for implementing one or more embodiments are described.

Operation

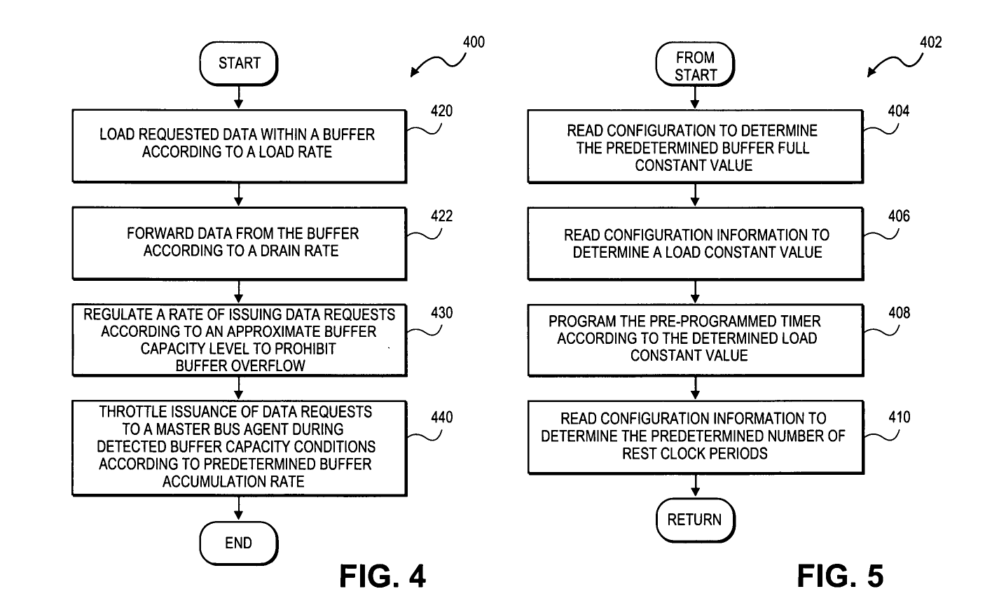

FIG. 4 is a flowchart illustrating a method 400 for implementing open loop buffer allocation, in accordance with one embodiment. As described herein, open loop buffer allocation refers to a buffer allocation technique wherein feedback regarding current buffer capacity is not required. Rather, based on initial configuration settings, such as may be read from preprogrammed initialization registers, open loop buffer allocation, in accordance with one embodiment, uses precomputed values. Such values include, but not limited, to a load-to-drain ratio of the system, a buffer size and a crossing clock penalty from going from a load clock domain to a drain clock domain to select a minimum number of buffer slots required to avoid buffer overflow, which is used as a baseline to select the buffer full constant value.

Referring again to FIG. 4, at process block 420, requested data is loaded within a buffer according to a load rate. For example, as illustrated with reference to FIG. 2, the load rate is based upon a memory (load) clock domain, such as, for example, 166 megahertz (MHz) and a bandwidth transferred per memory clock cycle (e.g. 32-bytes). At process block 422, data from the buffer is forwarded according to a drain rate. The drain rate may be based on a chain (graphics) clock domain having an operating frequency equal to, for example, 266 MHz and a bandwidth transferred per graphics clock cycle (e.g. 16-bytes).

Due to the difference in clock frequency between the load clock domain and the drain clock domain, as well as the load clock domain bandwidth, at process block 430, a rate of issuing data requests is regulated according to an approximate buffer capacity level to prohibit buffer overflow. In other words, an effective load rate from a master bus agent may exceed an effective drain rate of data to a target bus agent. As a result, buffering of such data may cause buffer overflow depending on a burst length of a data request. Hence, at process block 440, issuance of data requests to a master bus agent is throttled during detected buffer capacity conditions according to a predetermined buffer accumulate rate.

FIG. 5 is a flowchart illustrating a method 402 for initialization of the open loop buffer allocation, in accordance with one embodiment. At process block 404, one or more configuration registers are read to determine a predetermined buffer full constant value. At process block 406, configuration information is read to determine a load constant value. At process block 408, a preprogrammed timer is programmed according to the determined load constant value. At process block 410, configuration information is read to determine the predetermined number of rest clock periods. In one embodiment, the above-described gathering of configuration information is performed by initialization logic 470 of FIG. 2.

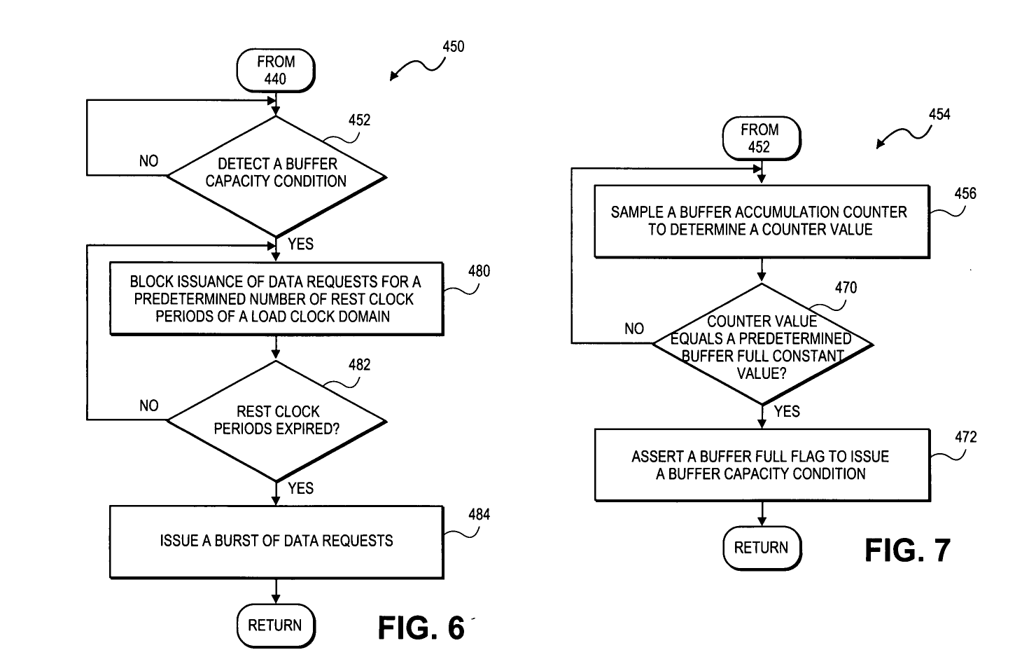

FIG. 6 is a flowchart illustrating a method 450 for regulating issuance of data requests of process block 440, in accordance with one embodiment. At process block 452, a buffer capacity condition is detected according to an approximate buffer capacity level. Once detected, at process block 480, issuance of data requests are blocked for a predetermined number of rest clock periods according to a load clock domain. At process block 482, it is determined whether the predetermined number of rest clock periods has expired. Once the rest clock periods have expired, a burst of data requests is issued to, for example, a master bus agent, such as, for example, a memory.

FIG. 7 is a flowchart illustrating a method 454 for detecting a buffer capacity condition of process block 452 of FIG. 6, in accordance with one embodiment. At process block 456, a buffer accumulation counter is sampled to determine a counter value. At process block 470, it is determined whether the counter value equals a predetermined buffer full constant value. When such is detected, at process block 472, a buffer flow flag is asserted to issue a buffer capacity condition.

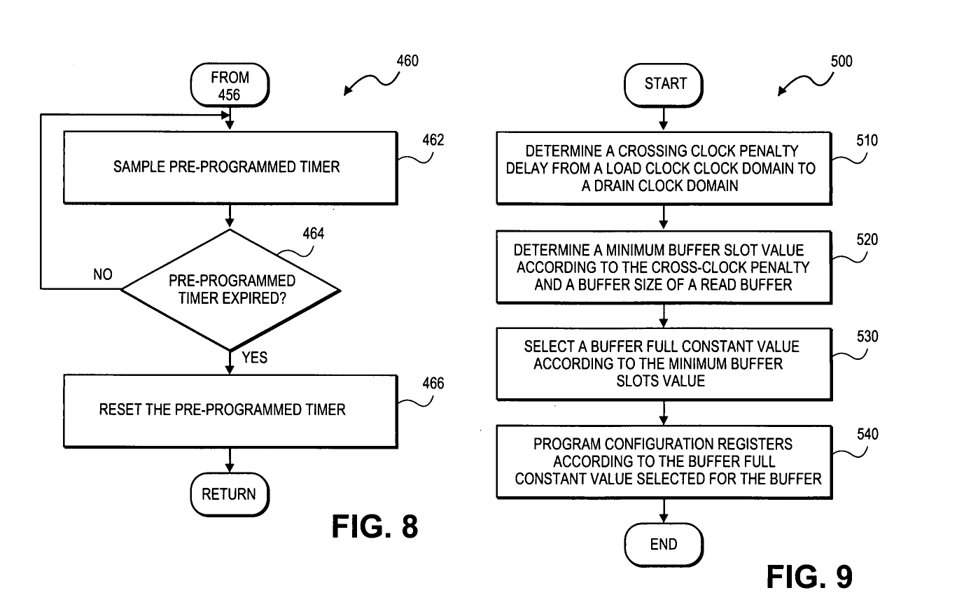

FIG. 8 is a flowchart illustrating a method 460 for incrementing a buffer accumulation counter, in accordance with one embodiment. At process block 462, a preprogrammed timer is sampled. At process block 464, it is determined whether the preprogrammed timer has expired. Once the preprogrammed timer has expired, the buffer accumulation counter is incremented. Subsequently, at process block 466, the preprogrammed timer is reprogrammed using, for example, the predetermined load constant value, and is reinitialized to begin timing.

FIG. 9 is a flowchart illustrating a method 500 for calculating a buffer full constant value and programming configuration registers to enable open loop buffer allocation, in accordance with one embodiment. At process block 510, a crossing clock penalty delay for a load clock domain to a drain clock domain is determined. Once determined, at process block 520, a minimum buffer slot value according to the crossing clock penalty and a buffer size of the buffer is determined. At process block 530, a buffer full constant value is selected according to the minimum buffer slots value. Finally, at process block 540, one or more configuration registers are programmed according to the buffer full constant value for the buffer to enable buffer logic to perform open loop buffer allocation, in accordance with one embodiment.

Open loop allocation, as described herein, may be used where die size is limited, which often prohibits the use of closed loop allocation schemes. Utilizing proposed open loop allocation scheme embodiments described herein, latency is reduced compared to closed loop allocation schemes while enabling, for example, a memory controller to sustain read streaming with a minimal size read buffer. Embodiments described herein facilitate maximum bandwidth usage for system configurations and also avoid read buffer overflow for system configurations where master bus agent bandwidth exceeds maximum bandwidth that can be supported by a target bus agent.

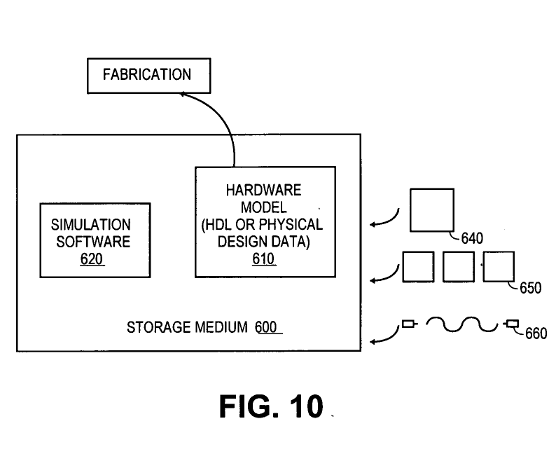

FIG. 10 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 610 may be stored in a storage medium 600, such as a computer memory, so that the model may be simulated using simulation software 620 that applies a particular test suite 630 to the hardware model to determine if it indeed functions as intended. In some embodiments, the simulation software is not recorded, captured or contained in the medium.

In any representation of the design, the data may be stored in any form of a machine readable medium. An optical or electrical wave 660 modulated or otherwise generated to transport such information, a memory 650 or a magnetic or optical storage 640, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### Alternate Embodiments

It will be appreciated that, for other embodiments, a different system configuration may be used. For example, while the system 100 includes a single CPU 102, for other embodiments, a multiprocessor system (where one or more processors may be similar in configuration and operation to the CPU 102 described above) may benefit from the open loop allocation scheme of various embodiments. Further different type of system or different type of computer system such as, for example, a server, a workstation, a desktop computer system, a gaming system, an embedded computer system, a blade server, etc., may be used for other embodiments.

Having disclosed exemplary embodiments and the best mode, modifications and variations may be made to the disclosed embodiments while remaining within the scope of the embodiments of the invention as defined by the following claims.

1. A method comprising:
loading requested data within a buffer according to a load rate;
forwarding data from the buffer according to a drain rate; and
regulating a rate of issuing data requests according to an approximate buffer capacity level to prohibit buffer overflow.

2. The method of claim 1, wherein prior to loading requested data, the method further comprises:
issuing a burst of read requests to a master bus agent according to a predetermined burst length.

3. The method of claim 1, wherein the load rate is greater than the drain rate.

4. The method of claim 1, wherein regulating comprises:
throttling issuance of data requests to a master bus agent during a detected buffer capacity condition according to a predetermined buffer accumulation rate.

5. The method of claim 1, wherein regulating further comprises:
detecting a buffer capacity condition;
blocking issuance of data requests for a predetermined number of rest clock periods of a load clock domain; and
issuing a burst of data requests once the predetermined number of rest clock periods has expired.

6. The method of claim 5, wherein detecting a buffer capacity condition comprises:
sampling a buffer accumulation counter to determine a counter value;
determining if the counter value equals a predetermined buffer full constant value; and
asserting a buffer full flag to issue a buffer capacity condition once the counter value equals the predetermined buffer full constant value.

7. The method of claim 6, wherein prior to querying the accumulation counter, the method further comprises:
sampling a preprogrammed timer;
incrementing the buffer accumulation counter once the preprogrammed timer has expired; and
resetting the preprogrammed timer if the preprogrammed timer has expired.

8. The method of claim 7, wherein prior to determining, the method further comprises:
reading configuration information to determine the predetermined buffer full constant value;
reading configuration information to determine a load constant value;
programming the preprogrammed timer according to the determined load constant value; and
reading configuration information to determine the predetermined number of rest clock periods.

9. The method of claim 1, wherein forwarding data comprises:
writing data from the buffer to a target bus agent each clock period of a drain clock domain following a predetermined crossing clock penalty delay.

10. The method of claim 1, wherein prior to loading, further comprises:
determining a crossing clock penalty delay from a load clock domain to a drain clock domain;
determining a minimum buffer slot value according to the cross-clock penalty and a buffer size of the buffer;
selecting a buffer full constant value according to the minimum buffer slot value; and
programming configuration registers according to the buffer full constant selected value.

11. A bus agent, comprising:
a controller to load requested data within a buffer according to a load rate, to forward data from the buffer according to a drain rate, and to regulate a rate of issuing data request according to an approximate buffer capacity level to prohibit buffer overflow.

12. The bus agent of claim 11, wherein the controller comprises:
a command controller to issue a burst of data requests to a master bus agent according to a predetermined burst length and throttle issuance of data requests to the master bus agent during detected buffer capacity conditions according to a predetermined buffer accumulation rate.

13. The bus agent of claim 11, wherein the controller further comprises:
buffer capacity logic to detect a buffer capacity condition and block issuance of data requests for a predetermined number of rest clock periods of a load clock domain.

14. The bus agent of claim 13, wherein the buffer capacity logic is to sample a buffer accumulation counter to determine a counter value, and assert a buffer full flag to issue a buffer capacity condition if the counter value equals a predetermined buffer full constant value.

15. The bus agent of claim 13, wherein the buffer capacity logic comprises:
counter increment logic to sample a preprogrammed timer, to increment the buffer accumulation counter if the preprogrammed timer has expired, and to reset the preprogrammed timer once the preprogrammed timer has expired.

16. The bus agent of claim 14, wherein buffer capacity logic further comprises:
initialization logic to read configuration information to determine the predetermined buffer full constant value, to read configuration information to determine a load constant value, to program the preprogrammed timer according to the determined load constant value, and to read configuration information to determine the predetermined number of rest clock periods.

17. The bus agent of claim 11, wherein the bus agent is a memory controller.

18. The bus agent of claim 11, wherein the bus agent is an input/output/(I/O) controller.

19. The bus agent of claim 11, wherein the bus agent is a system controller.

20. The bus agent of claim 11, wherein the controller is to write data from the buffer to a target bus agent each clock period of a load clock domain following a predetermined crossing clock penalty delay.

21. A system comprising:
a dual channel double data rate (DDR) memory;
a graphics engine; and
a chipset coupled to the DDR memory and the graphics engine, the chipset including a controller to load requested data within a buffer from the memory according to a load rate of the memory, to forward data from the buffer to the graphics engine according to a drain rate of the graphics engine, and to regulate a rate of issuing data requests to the memory according to an approximate buffer capacity level to prohibit buffer overflow.

22. The system of claim 21, wherein the controller comprises:
a command controller to issue a burst of data requests to a memory according to a predetermined burst length and throttle issuance of data requests to the memory during detected buffer capacity conditions according to a predetermined buffer accumulation rate.

23. The system of claim 21, wherein the controller further comprises:
buffer capacity logic to detect a buffer capacity condition and block issuance of data requests for a predetermined number of rest clock periods of a memory clock domain.

24. An article comprising a machine readable carrier medium carrying data which, when loaded into a computer system memory in conjunction with simulation routines, provides functionality of a model comprising:
a controller to load requested data within a buffer according to a load rate, to forward data from the buffer according to a drain rate, and to regulate a rate of issuing data requests according to an approximate buffer capacity level to prohibit buffer overflow.

25. The article of claim 24, wherein the controller comprises:
a command controller to issue a burst of data requests to a master bus agent according to a predetermined burst length and throttle issuance of data requests to the master bus agent during detected buffer capacity conditions according to a predetermined buffer accumulation rate.

26. The article of claim 24, wherein the controller further comprises:
buffer capacity logic to detect a buffer capacity condition and block issuance of data requests for a predetermined number of rest clock periods of a load clock domain.

27. The article of claim 24, wherein the controller is to write data from the buffer to a target bus agent each clock period of a drain clock domain following a predetermined crossing clock penalty delay.

28. The article of claim 24, wherein the buffer capacity logic comprises:
counter increment logic to sample a preprogrammed timer, to increment the buffer accumulation counter if the preprogrammed timer has expired, and to reset the preprogrammed timer once the preprogrammed timer has expired.
